(19) United States
(12) Patent Application Publication
(10) Pub. No.: US 2007/0287636 A1
(43) Pub. Date: Dec. 13, 2007

(54) Drilling fluid additive and base fluid compositions of matter containing B100 biodiesels; and applications of such compositions of matter in well drilling, completion, and workover operations

(75) Inventors: Douglas P. Heller, Malvern, PA (US); Jozef Bicerano, Midland, MI (US); Jimmy Earl Priest, Houston, TX (US)

Correspondence Address: Daniel H. Golub, 1701 Market Street, Philadelphia, PA, 19103, US

(73) Assignee: Sun Drilling Products Corporation, Belle Chasse, LA (US)

(21) Appl. No.: 11/810,979

(22) Filed: Jun. 7, 2007

Related U.S. Application Data
(60) Provisional application No. 60/812,262, filed on Jun. 9, 2006.

(51) Int. Cl. C09K 8/00; E21B 43/00

(52) U.S. Cl. 507/116; 507/218

(57) ABSTRACT

A drilling fluid compound, for use as an additive in a water-based drilling mud system, comprises a neat (B100) biodiesel liquid at a concentration of at least 5% by volume, and is useful in downhole applications such as lubrication, spotting, shale inhibition, fluid loss control, and rate of penetration enhancement. A base fluid for a synthetic-based drilling mud system comprises a B100 biodiesel liquid at a concentration of at least 5% by volume. A polyalphaolefin, another isomerized olefin, a petrodiesel, a mineral oil, a mineral oil derivative, or combinations thereof, may also be included in the drilling fluid compound or in the base fluid, within suitable ranges. The compositions of matter satisfy the current environmental standards defined by the U.S. Environmental Protection Agency for drilling fluids.

### CROSS-REFERENCE TO RELATED APPLICATIONS

This application claims priority to U.S. Provisional Application No. 60/812,262, filed Jun. 9, 2006, entitled “Use Of Biodiesel As A Drilling Fluid Or A Drilling Fluid Additive,” which is incorporated herein by reference.

### FIELD OF THE INVENTION

In one aspect, the present invention relates to a drilling fluid compound, for use as an additive in a water-based drilling mud system, that comprises a neat (B100) biodiesel liquid at a concentration of at least 5% by volume, and is useful in downhole applications such as lubrication, spotting, shale inhibition, fluid loss control, and rate of penetration enhancement. In another aspect, the present invention relates to a base fluid for a synthetic-based drilling mud system that comprises a B100 biodiesel liquid at a concentration of at least 5% by volume. A polyalphaolefin, another isomerized olefin, a petrodiesel, a mineral oil, a mineral oil derivative, or combinations thereof, may also be included in the drilling fluid compound or in the base fluid, within suitable ranges. In addition, the drilling fluid compound or base fluid may contain suitable performance-enhancing additives that may vary depending on the details of the application and of the downhole environment. The advantages of the preferred embodiments of the invention, which do not contain any petrodiesel, mineral oil or mineral oil derivatives, include nontoxicity, excellent biodegradability, lack of carcinogenic aromatics, being essentially sulfur-free; and not producing a visible sheen when discharged into water bodies. The most preferred embodiments, which also do not contain any polyalphaolefins or other isomerized olefins, manifest the highest levels of nontoxicity and biodegradability, as well as advantages in terms of sustainability resulting from their being based entirely on non-petrochemical resources.

### BACKGROUND

### A. Some Challenges of Drilling, Completion and Workover Operations

### 1. Needs for Lubrication and for Freeing Stuck Pipe

In the drilling (and sometimes also in the completion and workover) of oil and/or gas wells, a drill bit at the end of a rotating drill string or at the end of a drill motor is used to penetrate through geological formations. During this operation, a drilling mud is circulated through the drill string and out of the drill bit and is returned to the surface via the annular space between the drill pipe and the formation. The drilling mud, a fluid, cools and lubricates the drill string and drill bit; and is designed to counterbalance, through hydrostatic pressure, the encountered formation pressures while providing a washing action to remove the formation cuttings from the wellbore. The drilling mud also forms a friction-reducing wall cake between the drill string and the wellbore.

The drill string may demonstrate a tendency to develop unacceptable rotational torque during the drilling of a well, and in the worst cases it may even get stuck. At this point, the drill string cannot be raised, lowered and/or rotated; and this situation may even cause the well to be shut down. Some common factors that can lead to this situation are (a) cuttings or slough buildup in the borehole, (b) an undergauge borehole, (c) irregular borehole development causing the embedment of a section of the drill pipe into the drilling mud wall cake, and (d) unexpectedly encountered differential formation pressure.

In the case of differential sticking, the hydrostatic fluid pressure of the drilling mud is greater than the permeable pressure of the exposed formation, causing the flow of drilling mud into that area of the formation and thus lodging the drill pipe against the formation face. When this occurs, the contact area between the drill pipe and the formation is great enough to cause an increase in rotational torque, preventing the further movement of the drill pipe without running the risk of parting the drill pipe string.

### 2. Need for Shale Inhibition

It is a well-known challenge of drilling wells in clay formations containing shale (a fine-grained detrital sedimentary rock, formed by the compaction of clay, silt, or mud) that, when they are exposed to water-based fluids, such formations tend to hydrate, swell, and disperse or slough into the wellbore.

The effects of these chemical interactions can also be aggravated by the mechanical and physical effects of pipe rotation, erosion from fluid circulation, and overburden pressure; leading to hole enlargement, stuck pipe, and bottomhole assembly bailing.

It is, therefore, important in many applications of water-based drilling muds to use additives that help provide hole/shale stabilization via shale inhibition.

### 3. Need for Fluid Loss Control

Fluid loss is a measure of the tendency of the liquid phase of a drilling fluid to pass through the filter cake into the formation. A sufficiently low fluid loss value and the deposition of a thin filter cake possessing a low permeability are often essential factors for the successful performance of a drilling mud.

The relative importance of these filtration characteristics depends on the formation that is being penetrated. For example, drilling muds manifesting much higher fluid loss can be used in the hard rock formations of the Rocky Mountains and West Texas than in the sloughing, heaving, hydratable shales of the Gulf Coast Area. Experience in an area therefore often serves as a guide to determining the fluid loss specifications for a drilling mud program.

Many difficulties may occur in drilling, completion, and workover operations due to the use of a drilling mud with faulty fitration characteristics such as excessive filtration (fluid loss) rates and/or the buildup of a thick filter cake.

Excessive fluid loss can impede the evaluation of a formation since the recovery of the filtrate in addition to the formation fluids by the test tools can make it difficult to determine the true fluid content of the formation. More extreme fluid loss can even damage the formation.

The buildup of a thick filter cake can introduce tight spots in a hole causing excessive drag, greatly increase pressure surges due to the decreased pipe diameter when moving the pipe, differential pressure sticking of the drill string due to increased area of contact in thick filter cake and rapid buildup of sticking force in filter cake of high permeability, primary cementing problems due to poor displacement of dehydrated mud and excessively thick filter cakes, and difficulties with evaluating a formation.

It is, therefore, important in many applications of water-based drilling muds to use additives that can improve the filtration characteristics of the mud. Such additives are most commonly referred to as “fluid loss control agents”.

### 4. Need for Rate-of-Penetration (ROP) Enhancement

Drilling speed is quantified in terms of the ROP. It has important economic implications. If all other factors are kept constant, then a higher drilling speed leads to greater profitability. It is, therefore, important in many applications to use additives that provide ROP enhancement.

In general, ROP enhancement provided by the use of an additive package results from some combination of the following three main types of actions that enhance the ability of the drill bit to make smooth and continuous contact and thus achieve an enhanced penetration rate: (a) In what is essentially a lubricating action, it coats the metallic components (drill bit and drilling assembly), thus keeping them clean by preventing solids buildup (cuttings from sticking and balling up) on them. (b) It inhibits shale from swelling and becoming sticky, thus helping provide hole/shale stability. (c) It reduces fluid loss to the formation.

### B. Conventional Approaches to Overcoming These Challenges

Previous publications concerning methods of preventing a drill pipe from sticking and/or freeing a stuck drill pipe have most extensively discussed the use of an oil-based drilling mud or oil-based or water-based surfactant compositions, to reduce friction, permeate the drilling mud wall cake, destroy binding wall cake, reduce differential pressure, avoid swelling of shale, and controlling fluid loss.

Early developments in the field incorporated the use of refined crude oil, diesel, kerosene, and mineral oils into drilling fluids. Mineral oils with a low content of polynuclear aromatic compounds, as taught in World Patent No. WO8302949, were incorporated somewhat more recently. These types of developments focused mainly on applications involving oil-based drilling muds which were often found to provide better results in practice (such as better lubricity, faster drilling rates, and higher shale stability) than water-based drilling muds. Sáachez et al. (1999) showed that a new mineral oil-based drilling mud, where the base fluid contains less than 0.1% of aromatics, has far less environmental impact than a diesel-based drilling mud.

The typical previously developed oil-based drilling fluid additives, which were based on refined mineral oils and processed vegetable oils along with emulsification and dispersant additive packages, suffer from many drawbacks, the most pertinent being high toxicity to marine life. For example, if the oil in an offshore drilling operation spills over into the water, the mineral oil (and to a somewhat lesser but still often unacceptable extent also the vegetable oil), due to its heavy oily nature, tends to coat the gills of marine animals and destroy valuable marine life. Furthermore, vegetable oils often do not perform as effectively as mineral oils.

### C. A Paradigm Shift Resulting from New Governmental Regulations

In 1994, Clark published a review of the profound impact of the growing demands placed by governmental regulations on drilling fluid technology. As detailed in this review, a turning point came in 1986 when regulations took effect that placed a limit on the toxicity of the water-based drilling fluids being discharged into the Gulf of Mexico. These regulations stimulated major changes in the types of drilling mud systems and additives that were being used. The performance demands dictated by the new types of wells being drilled (such as deepwater, extended-reach, horizontal, and slimhole wells) further stimulated the development of new types of drilling mud systems and additives.

The current environmental standards applicable to drilling fluids, as defined by the U.S. Environmental Protection Agency (EPA), are to satisfy the 275-day biodegradation and 10-day Leptocheirus plumulosus toxicity tests in effect as of the date of this application (respectively, the “275-day biodegradation test” and “10-day Leptocheirus plumulosus toxicity test”) and not to produce a surface sheen on the water body based on the static sheen test in effect as of the date of this application (referred to herein as the “static sheen test”). The method for performing the 275-day biodegradation test is defined in Federal Register, Part IV Environmental Protection Agency, 40 CFR Parts 9 and 35 entitled “Effluent Limitations Guidelines and New Source Performance Standards for the Oil and Gas Extraction Point Source Category”, Fed. Reg. Vol. 66, No. 14, Jan. 22, 2001, Appendix 4 to Subpart A of Part 435, incorporated herein by reference. The 275-day biodegradation test described in Appendix 4 to Subpart A of Part 435 is based on a modification of ISO Standard No. 11734:1995 (also incorporated herein by reference) for use in a marine environment. The 10-day Leptocheirus plumulosus toxicity test is defined in Annex A.1 of ASTM Standard No. E1367-03^{ε1} which is incorporated herein by reference. The static sheen test is defined in 40 CFR 435, Appendix 1 to Subpart A, also incorporated herein by reference.

The following facts should be noted as general background information in the context of discussions of environmental impact: (a) the 10-day Leptocheirus plumulosus toxicity test is a measure of acute toxicity. (b) Biodegradation can be measured both in aerobic environments (in the presence of oxygen) and anaerobic environments (in the absence of oxygen). It is most desirable for a drilling fluid to be highly biodegradable under both aerobic and anaerobic conditions. (c) Appearance of a visible sheen on the receiving waters upon the discharge of a drilling fluid and/or cuttings produced during a drilling operation using that drilling fluid is highly undesirable because it indicates the presence of “free oil”.

### D. Ester-Based Drilling Fluids

Several articles published on ester-based drilling fluids during the last two decades [Yassin and Kamis (1990), Sáchez et al. (1999), Hall (1999), Hall et al. (2001), and Tapavicza (2005)] summarize some of the rapid advances being made in this very promising direction of research and development. It is worth noting that esters derived from palm oil appear to have received the most attention thus far in work for the development of ester-based drilling fluids.

The key material properties of ester-based fluids, such as their rheological characteristics and lubricities, are very suitable for drilling fluid applications. Furthermore, these properties can be varied by selecting esters of different molecular structures (or mixtures thereof) to obtain optimized compositions for different downhole environments.

Such fluids also offer a favorable choice in terms of environmental friendliness. More specifically, (a) they are nontoxic, (b) they undergo biodegradation substantially faster than other types of fluids possessing properties that are suitable for use as drilling fluids, (c) they contain no carcinogenic aromatics, (d) they are essentially sulfur-free, and (e) they can be derived by the chemical processing of non-petrochemical resources (such as oils, fats and greases obtained from a wide range of plant and animal sources) so that they offer advantages in terms of sustainability.

The rapid anaerobic biodegradation of a drilling fluid is crucial for minimizing the environmental impact of offshore and waterflooded drilling operations. Ester-based drilling fluids exhibit superior performance with respect to biodegradability in anaerobic environments. For example, esters derived from palm oil have been shown to degrade back rapidly to fatty acids and alcohol via hydrolysis even in anaerobic conditions. With the passage of more time, these products of the initial degradation biodegrade further to carbon dioxide and water.

The following are examples of patents on the development of ester-based drilling fluids and drilling fluid additives: U.S. Pat. No. 3,668,129, U.S. Pat. No. 4,631,136, U.S. Pat. No. 5,007,489, U.S. Pat. No. 5,252,554, U.S. Pat. No. 5,728,658, U.S. Pat. No. 5,807,811, U.S. Pat. No. 6,489,272, U.S. Pat. No. 6,589,917, U.S. Pat. No. 6,800,594, U.S. Pat. No. 6,887,832, U.S. 20040002427, U.S. 20050233911, U.S. 20070078060, U.S. 20070078061, U.S. 20070078062, U.S. 20070082822, EP0374672, EP0542808, EP0652271, and W09810039. It will be seen that the present invention, which will be taught in later sections of this document, differs from this prior art on ester-based drilling fluids and drilling fluid additives both in its conceptual approach and in its modes of implementation.

The esters used in ester-based drilling fluids are most commonly derived by the chemical (synthetic) processing of precursor oils. Such fluids could, hence, be considered both as being oil-based and as being synthetic-based. We will categorize them as synthetic drilling fluids, in accordance with the terminology recommended by World Oil, Special Supplement on Drilling, Completion and Workover Fluids, “Classifications of Fluid Systems”, Gulf Publishing Company, Houston, Tex. (June 2006) as reflecting general industry practice.

### E. Use of Polyalphaolefins in Drilling Fluids

In another especially promising development, it was discovered that synthetic oils and isoparaffinic oils with no aromatic content, and in particular a class of synthetic oils known as polyalphaolefins (as taught in U.S. Pat. No. 4,876,017 and U.S. Pat. No. 5,045,219), demonstrate the required fluid properties and comply with the EPA criteria to function as the primary ingredients of downhole fluid additives; more specifically, as a lubricant, spotting fluid, shale inhibitor, fluid loss control agent, and ROP enhancer. The use of polyalphaolefins in such drilling fluid additives enabled water-based drilling muds to provide levels of downhole performance that, with earlier technologies, usually required the use of oil-based drilling muds.

This technology is currently available commercially through the CoastaLube®, C-Mul® and SunSpot® products of the Sun Drilling Products Corporation, the assignee of the present application.

### SUMMARY OF THE INVENTION

### A. B100 Biodiesel as a Key Drilling Fluid Ingredient

### 1. Overview

The need to achieve the environmental and performance benefits of polyalphaolefin-containing and/or other isomerized olefin-containing drilling fluid compounds during well drilling, completion and workover operations with compounds where some or all of the polyalphaolefin and/or other isomerized olefin is replaced with an alternative formulation ingredient that is derived from non-petrochemical feedstocks, less expensive, and substantially more biodegradable, is met with the present invention.

A common aspect of the compositions of matter of the present invention is that they all comprise a B100 biodiesel-based formulation at a liquid concentration of at least 5% by volume.

These compositions of matter may also optionally comprise a polyalphaolefin, another isomerized olefin, or combinations thereof, at any concentration subject solely to the limitation that the concentration of a B100 biodiesel-based formulation in the composition must be at least 5% by volume.

In one aspect, the present invention deals with a drilling fluid compound, comprising a neat biodiesel liquid (designated as “B100”) at a concentration of at least 5% by volume, used in a concentration of at least 0.25% by volume as an additive in a water-based drilling mud system, to lubricate the drill pipe while rotating or pulling past a mud filter cake, hard or soft rock, or casing in a well bore; to unstick drill pipe that has become differentially stuck; to help ensure hole/shale stability; for fluid loss control; and for rate-of-penetration (ROP) enhancement.

In another aspect, the present invention deals with the use of a B100 biodiesel liquid at a concentration of at least 5% by volume in a base fluid for synthetic-based drilling muds.

In yet another aspect, the present invention deals with the use of B100 biodiesel-based formulations where small quantities of a petrodiesel, mineral oil, mineral oil derivatives, or combinations thereof are mixed with a B100 biodiesel and the resulting liquid composition still satisfies the same environmental testing standards, at a concentration of at least 5% by volume in drilling fuid compounds used as an additive in a water-based drilling mud system or in a base fluid for synthetic-based drilling muds.

### 2. ASTM Standard Definition of a B100 Biodiesel

The “Standard Specification for Biodiesel Fuel Blend Stock (B100) for Middle Distillate Fuels”, ASTM Standard No. D6751-07a, ASTM International (2007), attempts to standardize the definitions of some key terms, to specify a detailed set of requirements that must be met by a B100 biodiesel, and to enumerate the tests to be used to determine whether a substance meets these requirements. While it was developed with the commercial use of biodiesel in on-road and off-road diesel engine applications as its main focus, ASTM Standard No. D6751-07a is also useful in the broader context of providing greater specificity to what is meant by the term “biodiesel”, which it defines as “a fuel comprised of mono-alkyl esters of long chain fatty acids derived from vegetable oils or animal fats, designated B100”. The “B100” designation thus indicates that the material consists of 100% biodiesel, not mixed with any petrodiesel.

### 3. Definition and Use of a B100 Biodiesel-Based Formulation in Context of Present Invention

In the context of this application, the “B100 biodiesel-based formulation” designation corresponds to a fuel comprised of mono-alkyl esters of long chain fatty acids derived from vegetable oils or animal fats, designated B100 by ASTM Standard No. D6751-07a, which is (a) not mixed with any petrodiesel, mineral oil, or mineral oil derivative; or (b) mixed with a small enough amount of petrodiesel, mineral oil, mineral oil derivative, or combination thereof, that when it is used either in a drilling fluid compound as an additive to a water-based drilling mud or as a base fluid in a synthetic-based drilling mud, the resulting drilling fluid composition still satisfies the 275-day biodegradation test, 10-day Leptocheirus plumulosus toxicity test,and static sheen test.

The use of a B100 biodiesel in a drilling mud system has the benefits of environmental friendliness (nontoxic, biodegradable, no carcinogenic aromatics, essentially sulfur-free, not producing a visible sheen when discharged into water bodies) while providing the necessary attributes of common oil-based drilling mud systems. These attributes of B100 biodiesel stand in striking contrast to the severe environmental impact (and in particular high toxicity and low biodegradability) of petrodiesel which was utilized extensively in drilling fluid formulations until its use began to be curtailed by governmental regulations resulting from concerns about its environmental impact. Various types of mineral oils and mineral oil derivatives generally fall between B100 biodiesel and petrodiesel in their environmental friendliness. Consequently, B100 biodiesel-based formulations that do not contain any petrodiesel, mineral oil or mineral oil derivative provide the best environmental advantages.

Nonetheless, B100 biodiesel-based formulations containing a small amount of a petrodiesel, mineral oil, mineral oil derivative, or combinations thereof, may provide downhole performance advantages without unacceptable environmental damage. Such formulations, where a B100 biodiesel is mixed with a small enough amount of a petrodiesel, mineral oil, mineral oil derivative, or combination thereof, that the resulting fluid composition still satisfies the 275-day biodegradation test, 10-day Leptocheirus plumulosus toxicity test, and static sheen test, are also within the scope of the present invention.

### 4. Sources for and Manufacturing of a B100 Biodiesel

B100 biodiesel may be manufactured from various forms of oils, fats and greases; as reviewed, for example, in “A Biodiesel Primer: Market & Public Policy Developments, Quality, Standards & Handling”, published by Methanol Institute and International Fuel Quality Center (April 2006). As summarized in that review report, “Biodiesel is generally made when fats and oils are reacted chemically with an alcohol, typically methanol, and a catalyst, typically sodium or potassium hydroxide (i.e., lye), to produce an ester, or biodiesel.”

Without limiting the scope of the invention, specific examples of feedstocks that can be used to produce B100 biodiesel include virgin vegetable, seed and other plant-based oils such as soy, mustard, canola, rapeseed, mamouna, palm, babassu, pine, coffee, cottonseed, sunflower, jojoba, tung, castor, olive, peanut, cashew nut, pumpkin seed, corn, rice, perilla, sesame, coconut, safflower, linseed, hemp, Chinese tallow tree, tall oil, and similar types of oils; animal fats such as poultry offal, tallow, lard, butter, neatsfoot and fish oils; and used cooking oils and trap grease from restaurants.

### 5. Summary of Differences Between Present Invention and Prior Art

As will become obvious from the further description to be provided below, while it involves the use of esters in drilling fluid compositions, the present invention differs substantially, both in its conceptual approach and in its modes of implementation, from the prior art on ester-based drilling fluids and drilling fluid additives cited in the BACKGROUND section.

One general mode of implementation of the present invention is based on the recognition that B100 biodiesels derived from various plant or animal sources can provide ester compositions that are especially suitable for use as the base fluids in additives that are then incorporated into water-based drilling muds.

Another general mode of implementation of the present invention is based on the recognition that B100 biodiesels derived from various plant or animal sources can provide ester compositions that are especially suitable for use as the base fluids in synthetic-based drilling muds.

Some implementations of the present invention are based on the recognition that other liquids, such as petrodiesel, mineral oils, mineral oil derivatives, or combinations thereof, can be blended in limited quantities with a B100 biodiesel, to obtain B100 biodiesel-based formulations that may provide improved levels of performance while keeping the environmental impact at an acceptable level.

Some implementations of the present invention are based on the recognition that blending a polyalphaolefin and/or other isomerized olefin with a B100 biodiesel-based formulation can be a highly effective means for producing both compositions that are especially suitable for use as base fluids in additives that are then incorporated into water-based drilling muds and compositions that are especially suitable for use as base fluids in synthetic-based drilling muds.

Various modes of implementation of the invention are described in greater detail in the following sections of this patent. Different types of additives and additive packages that can be blended into a B100 biodiesel-based formulation are mentioned. Such additives include, but are not limited to, emulsifiers, thinners (which primarily function as deflocculants that reduce the flocculation of clay particles), surfactants, electrolytes, viscosifiers, polymeric inhibitors, clays, starches, alkalinity and pH control additives, bactericides, calcium reducers, corrosion inhibitors, defoamers, hydrate suppressants, and temperature stability agents. However, the present disclosure emphasizes the use of a B100 biodiesel-based formulation as a base fluid in additives that are then incorporated into water-based drilling muds and as a base fluid in synthetic-based drilling muds, rather than any specific additives or additive packages that may be incorporated into the B100 biodiesel-based formulation. Many suitable additives and/or additive packages may be incorporated into the B100 biodiesel-based formulation depending on the application.

### B. Use in Additives for Water-Based Drilling Muds

### 1. Lubrication

A B100 biodiesel-based formulation is blended in various concentrations with suitable emulsifiers, thinners and surfactants. The concentration of B100 biodiesel-based formulation in the blend is no less than 5% by volume. The B100 biodiesel-based formulation and suitable additives are blended in a blending tank containing a water-based drilling mud in a concentration of at least 0.25% by volume. The blend of B100 biodiesel-based formulation and additives is circulated with the water-based drilling mud downhole, to lubricate the drill string or reduce the rotational torque or drag between the wall of the borehole and the drill string so that the drill string is free to rotate. Consequently, drilling, completion and workover operations may be undertaken with less drag or torque.

### 2. Unsticking Stuck Drill Pipe

A B100 biodiesel-based formulation blended with suitable additives serves as a spotting fluid in order to unstick drill pipe that has become stuck. In this application, the B100 biodiesel-based formulation is blended with emulsifiers, thinners and surfactants, in a concentration of at least 5% by volume of B100 biodiesel-based formulation; the blend is introduced into the borehole as a “pill”; the pill is circulated downhole in the mud system through the annulus to the depth at which the pipe is stuck; and the blend acts on the wall filter cake reducing the differential pressure bond.

### 3. Shale Inhibition

Blending a B100 biodiesel-based formulation with suitable additives (with the concentration of B100 biodiesel-based formulation in the blend being no less than 5% by volume), incorporating the blend into a water-based drilling mud in a blending tank in a concentration of at least 0.25% by volume, and circulating the blend with the water-based drilling mud downhole, helps ensure hole/shale stability by coating the clay and thus inhibiting shale from swelling and becoming sticky.

### 4. Fluid Loss Control

Blending a B100 biodiesel-based formulation with suitable additives (with the concentration of B100 biodiesel-based formulation in the blend being no less than 5% by volume), incorporating the blend into a water-based drilling mud in a blending tank in a concentration of at least 0.25% by volume, and circulating the blend with the water-based drilling mud downhole, helps reduce fluid loss to the formation. Furthermore, fluid loss control agents can also help produce a thin and tight filter cake having low porosity and low permeability.

### 5. Rate of Penetration (ROP) Enhancement

Blending a B100 biodiesel-based formulation with suitable additives (with the concentration of B100 biodiesel-based formulation in the blend being no less than 5% by volume), incorporating the blend into a water-based drilling mud in a blending tank in a concentration of at least 0.25% by volume, and circulating the blend with the water-based drilling mud downhole, provides ROP enhancement.

### C. Use as Base Fluids for Synthetic-Based Drilling Muds

In another general mode of application of the invention, a B100 biodiesel-based formulation is used as a base fluid, or as a base fluid component at a liquid concentration of at least 5% by volume, in synthetic-based drilling muds. The base fluids used in conventional oil-based drilling muds do not comply with the 275-day biodegradation test and 10-day Leptocheirus plumulosus toxicity test. The replacement of such base fluids by a B100 biodiesel-based formulation provides the ability to use a synthetic-based drilling mud that mirrors oil-based mud performance without the environmental damage of an oil-based mud.

The base fluids of the present invention can be combined with additives that are suitable for performing functions such as, but not limited to, lubrication, unsticking drill pipe, ensuring hole/shale stability via shale inhibition, fluid loss control, enhancing rate of penetration, rheology control, stabilization of emulsions, corrosion control, and coring.

### D. Optional Use of Mixtures of Different Components of a Given General Type

It is to be understood that the compositions of matter of this invention may employ a single component of a specified type or any of the many possible combinations of component mixtures of a specified type. For instance, when we refer to the use of “a B100 biodiesel” as a component of a drilling fluid compound, it is to be understood that, in addition to compositions using a single type of B100 biodiesel lubricant fluid, the drilling fluid compound may include mixtures of B100 biodiesel fluids obtained from different feedstocks. Without limiting the scope of the invention, blends of B100 biodiesels derived from rapeseed and from cottonseed in any desired relative amounts would be some specific examples of such mixtures.

### BRIEF DESCRIPTION OF THE DRAWING

The accompanying drawing, which is included to provide further understanding of the invention and is incorporated in and constitute a part of this specification, illustrates the performance of some preferred embodiments of the invention and, together with the description, serves to explain the principles of the invention.

FIG. 1 shows the results of measurements of frictional resistance reduction, relative to a baseline frictional resistance of 150 inch·pounds, provided by several formulations in a metal-to-metal lubricity test (where the metal was 4140 steel) performed on a Baroid lubricity meter. The following ten specific samples were compared: (a) base mud (a simple, low-solids, nondispersed water-based 8 API drilling mud of 10.3 lb/gallon density and pH 10.3); (b) base mud with 5%, 10% and 15% by volume of Cottonseed B100 Biodiesel only; (e) base mud with 5%, 10% and 15% by volume of Cottonseed B100 Biodiesel modified by blending with a standard C-Mul® additive package, where the C-Mul® additive package comprises 7% by volume of the blend; and (d) the base mud with 5%, 10% and 15% by volume of Cottonseed B100 Biodiesel modified by blending with with a standard CoastaLube® additive package, where the CoastaLube® additive package comprises 5% by volume of the blend. As a point of reference, frictional resistance levels ranging from 49.5 to 54.0 inch·pounds were observed when water was instead used as a lubricant. A lower frictional resistance indicates greater effectiveness as a lubricant.

FIG. 2 shows the measured API fluid loss (filtrate volume) in milliliters (ml) for the ten samples described in the caption of FIG. 1.

FIG. 3 shows the measured HPHT fluid loss (filtrate volume) in milliliters (ml) at a temperature of 250° F. for the ten samples described in the caption of FIG. 1.

### DESCRIPTION OF THE PREFERRED EMBODIMENTS

The following currently preferred embodiments of the invention are provided as illustrative examples, without limiting the full scope of the invention as described in the SUMMARY OF THE INVENTION section and further specified in the claims. A vast number and variety of additional embodiments can be imagined readily by workers of ordinary skill in the field of the invention with the benefit of this disclosure.

### A. B100 Biodiesel as a Key Drilling Fluid Ingredient

B100 biodiesel obtained from cottonseed oil, rapeseed oil, palm oil, or a combination thereof, is used in the currently preferred embodiments of the invention. Petrodiesel, mineral oils, and mineral oil derivatives, are all excluded from the currently preferred embodiments, which may, however, include a polyalphaolefin, another isomerized olefin, or a combination thereof, in addition to a B100 biodiesel. The currently most preferred embodiments go further, by also excluding polyalphaolefins and other isomerized olefins.

It is foreseen that the preferred and especially the most preferred embodiments would be preferentially utilized particularly in offshore applications (as well as in other environmentally sensitive areas) since a B100 biodiesel is both completely nontoxic to marine life and highly biodegradable so that it offers no threat in its offshore application should a spill occur.

### B. Use in Additives for Water-Based Drilling Muds

### 1. General Aspects of Preferred Embodiments

The currently preferred embodiments of the invention intended for use as additives for water-based drilling muds utilize a B100 biodiesel liquid, or mixtures of B100 biodiesel liquids, in a concentration range of 70% to 95% by volume; with other liquid additives blended in a total concentration of 30% to 5% by volume; to function as a water-based drilling mud lubricant, spotting fluid, shale inhibitor, fluid loss control agent, and/or ROP enhancer. The B100 biodiesel-additive blend is used at a concentration of 0.25% to 15.0% by volume in the water-based drilling mud system.

The components blended in a B100 biodiesel for such applications include, but are not limited to, any suitable additives selected from the group consisting of emulsifiers, thinners, surfactants, electrolytes, viscosifiers, polymeric inhibitors, clays, starches, alkalinity and pH control additives, bactericides, calcium reducers, corrosion inhibitors, defoamers, hydrate suppressants, and temperature stability agents. A suitable additive package may consist, for example, of a blend of sulfurized fatty acids and modified fatty acids for lubrication; a blend of modified fatty acid and amides for spotting; a blend of electrolytes, inhibiting polymers and/or thinners for shale inhibition; a clay, a starch, a polymeric loss control agent, or combinations thereof, for fluid loss control; and a blend of lubricating, shale inhibiting, and fluid loss control additives for ROP enhancement. The selection of a suitable additive package is a matter of design choice (dependent on the application of interest) and not within the scope of the present invention.

### 2. Lubrication

As was discussed earlier, as the drill string rotates through the formation, the torque and/or drag may increase, and lubrication of the drill string is hence critical to prevent the torque and/or drag from becoming unacceptably large. A lubricant is, therefore, introduced into the water-based drilling mud system to lubricate the drill string.

The additives incorporated into a B100 biodiesel for the lubricant application mainly include various emulsifiers, thinners and surfactants. The B100 biodiesel-additive blend can be incorporated into a water-based mud system, for example by introducing the blend into the mud pit, without interrupting the flow of the drilling mud, since the blend can be mixed into the mud system as the mud system is being introduced downhole. Once it reaches the downhole environment, the blend helps lubricate the surface between the wall of the drill pipe and the wall of the surrounding formation, so as to reduce the torque and drag on the drill string during downhole drilling, completion and workover operations.

In one embodiment where a B100 biodiesel (which does not contain any petrodiesel) is being used, the biodiesel liquid is nontoxic to marine life, and can therefore be maintained in the mud system during drilling, and the drill cuttings do not have to be recovered and may be discharged. By contrast, with most of the previous approaches (with the exceptions of water-based drilling muds incorporating polyalphaolefins and ester-based drilling muds), the drilling mud system would have 10-day Leptocheirus plumulosus toxicity test levels above acceptable limits and/or fail the static sheen test. In order to avoid the possibility of the spreading of the lubricant into the surrounding seawater (thus creating a hazard to marine life), the drilling fluid and cuttings would necessitate containment. The compositions of matter of the present invention overcome this challenge. They can be kept in the drilling mud system, allowing the normal discharge of drilling fluids and/or cuttings.

### 3. Unsticking Stuck Drill Pipe

In this application, a B100 biodiesel-additive blend is utilized downhole in the same concentration range, with the same types of additives as in the lubrication application, to unstick a drill string that has become stuck to the wall of the formation due to various factors including differential pressure downhole. The specific additives and the specific amounts of these additives for this application may differ from those for the lubrication application, although both applications utilize the same general types of additives in the same overall range of amounts. Again, the selection of a suitable additive package is a matter of design choice (dependent on the application of interest) and not within the scope of the present invention.

Most commonly, the normal circulation of a water-based mud system is altered to allow a certain volume of a B100 biodiesel-additive blend to be introduced as a “pill” into the active mud system, thus causing a larger amount of the blend to be applied at a predetermined point downhole. Following the introduction of the blend into the borehole, the blend is then displaced into the annulus in the borehole at the estimated level that the drill string has become stuck. The blend then serves as a spotting fluid in order to, for example, replace the water in the mud wall cake causing the sticking of the pipe against the wall mud cake due to differential pressure, thus relieving that pressure and rotational torque in order to allow the drill string to resume rotational and vertical movement.

Again, since the B100 biodiesel-additive blend is nontoxic to marine life, the pill can be left downhole and recirculated in the system where it can thereafter function as a lubricant, and does not need to be isolated and removed from the active mud system. By contrast, if a typical oil-based spotting fluid is introduced downhole as a pill, the EPA may require that 50 barrels of mud preceeding and following the pill be retrieved together with the pill in order to avoid contamination of the mud system by toxic substances.

### 4. Shale Inhibition

An inhibitive drilling mud is a fluid which does not allow the appreciable alteration of a formation once the formation has been cut by the drill bit. This implies that an inhibitive drilling mud resists the disintegration and hydration of drilled solids, and stabilizes the wellbore.

Inhibitive water-based drilling muds can be formed by three main methods; namely, (a) addition of various electrolytes, (b) addition of inhibiting polymers, and (c) addition of certain thinners at quantities that are sufficient to retard hydration. Any one or a combination of these three major methods may be used for the preparation of an inhibitive water-based drilling mud for use in shale inhibition under different downhole circumstances. In preferred embodiments of the present invention targeted for shale inhibition applications, the additives are mixed in a B100 biodiesel liquid prior to being incorporated into an inhibitive water-based drilling mud.

The following are some specific examples of suitable additives: (a) Saltwater muds use sodium chloride (NaCl) for inhibition. (b) Potassium-treated muds may incorporate potassium hydroxide (KOH), potassium chloride (KCl), potassium lignites and other potassium complexes for inhibition. (c) Calcium-treated muds may use lime (CaO), gypsum (CaSO₄·2H₂O) or calcium chloride (CaCl₂) for inhibition. (d) Polymer muds rely on the encapsulating mechanism of a polymer, such as cellulose, natural gum-based products, or partially hydrolyzed polyacrylamide, for inhibition. Inhibiting salts such as KCl or NaCl are often used in additive packages along with inhibiting polymers to provide even greater shale stability than provided by the inhibiting polymers or the inhibiting salts by themselves. Inhibiting polymers may also some serve additional important functions in some water-based muds, such as the viscosification of the mud and/or the encapsulation of the cuttings to prevent their dispersion. (e) Inhibition can also be achieved by using a high concentration of thinners such as SPERSENE® chrome lignosulfonate (a multi-purpose deflocculant and gel strength reducer, temperature stabilizer and filtration-control additive) and/or XP-20®.

Inhibitive mud systems impart special properties to the drilling fluid. These muds have low viscosity, low gel strength, good solids tolerance, and good contamination resistance. Their principal application is for drilling shale and clay formations with weighted muds. Hydration of shales and clays is retarded, the formation of a heaving shale and/or a tight hole are prevented, and a more stabilized borehole results. Furthermore, even if they are drilled in large quantities, contaminants such as salt, cement and anhydrite (CaSO₄) may be successfully handled with the help of certain inhibitive muds.

### 5. Fluid Loss Control

The most satisfactory method for controlling fluid loss is to reduce the permeability of the filter cake. The size, shape, and ability of the particles to deform under pressure (resulting in a highly compressible filter cake) are all important factors in the control of permeability. Small, flat (platelet-shaped) and deformable colloidal particles that possess a range of sizes provide optimum fluid loss control. Bentonite particles meet all of these requirements quite well. It is, therefore, not surprising that bentonite clays are widely used as fluid loss control agents.

The flocculation of clay platelets can result in an increased permeability of the filter cake and hence greater fluid loss. This problem can be corrected by adding chemical deflocculants which neutralize the electrochemical charges that cause the clay platelets to flocculate, allowing the clay platelets to disperse and overlap and thus providing a tighter filter cake.

Lignite, sodium polyacrylate, and various organic colloids (such as pregelatinized corn starch, pregelatinized potato starch, and sodium carboxymethylcellulose) are other examples of fluid loss control agents that can be incorporated into a B100 biodiesel to reduce fluid loss.

### 6. Rate of Penetration (ROP) Enhancement

Preferred embodiments of the invention that are intended mainly for use in ROP enhancement typically contain mixtures of lubricating, shale inhibition, and fluid loss control additives. The selection of a suitable additive package for ROP enhancement applications is a matter of design choice and not within the scope of the present invention. However, the additives are preferably mixed in a B100 biodiesel liquid prior to being incorporated into a water-based drilling mud system.

### C. Use as Base Fluids for Synthetic-Based Drilling Muds

Other currently preferred embodiments of the invention use a B100 biodiesel as a nontoxic replacement for the conventional types of oils used as base fluids in oil-based drilling muds. When a B100 biodiesel (or a mixture of a B100 biodiesel with a polyalphaolefin, another isomerized olefin, or a combination thereof) is used as a base fluid in a synthetic-based drilling mud system, it can be combined with additives that are suitable for performing functions such as, but not limited to, lubrication, unsticking drill pipe, ensuring hole/shale stability via shale inhibition, fluid loss control, enhancing rate of penetration, rheology control, stabilization of emulsions, corrosion control, and coring.

It is important to emphasize, however, that the additives or additive packages that may be incorporated into a B100 biodiesel are a matter of design choice and are not within the scope of the present invention.

Synthetic-based drilling mud systems utilizing the B100 biodiesel (or mixture of B100 biodiesel with a polyalphaolefin, another isomerized olefin, or a combination thereof) base fluids of the invention are used most beneficially in those downhole environments where oil-based or synthetic-based drilling mud systems provide optimum levels of performance. Standard methods for applying oil-based or synthetic-based drilling mud systems, which are known to workers of ordinary skill in the field of the invention, can be used for applying drilling mud systems using the base fluids of the invention.

### EXAMPLES

Some non-limiting examples of preferred embodiments of the fracture stimulation method of the invention will now be given, without reducing the generality of the invention, to provide a better understanding of some of the ways in which the invention may be practiced. Workers skilled in the art can readily imagine many additional embodiments of the invention with the benefit of this disclosure.

### A. Properties of Various Biodiesels and Glycerol in a Synthetic-Based Drilling Mud

The first stage of the experimental work consisted of the measurement of many properties of four samples in an 11.5 lb/gallon synthetic-based drilling mud by using standard testing methods; at Mudtech Laboratories, in Houston, Tex.

The tests on two of the samples (Glycerol and Poultry B100 Biodiesel) could not be completed because these two fluids became extremely thick during the mixing process.

The properties of the drilling mud systems containing the other two samples (Generic Biodiesel and Cottonseed B100 Biodiesel) were measured initially and after hot rolling at 300 ° F. or at 350° F. for 16 hours. The results are summarized in TABLE 1.

While both samples manifested attractive measured property profiles, the Generic Biodiesel sample produced an extremely foul odor when running the retort. Such an odor would not necessarily rule out its practical use. It would, however, place Generic Biodiesel at a distinct disadvantage compared with other materials which can perform comparably without producing a foul odor. It was, thus, concluded that the Cottonseed B100 Biodiesel provided the best overall balance of properties from among the four samples that the experiments were started with.

TABLE 1
Properties of a Generic Biodiesel sample and a Cottonseed B100 Biodiesel sample.

| | Generic Biodiesel | | | Cottonseed B100 | | |
|---|---|---|---|---|---|---|
| Measured Property (units) | Initial | 300° F. | 350° F. | Initial | 300° F. | 350° F. |
| Electrical Stability (volts) | 1190 | 1434 | 1724 | 970 | 1005 | 1170 |
| Mud Density (lb/gallon) | 12.4 | 12.5 | 12.6 | 12.4 | 12.4 | 12.4 |
| 600 rpm at 120° F. | 122 | 204 | 338 | 126 | 235 | 338 |
| 300 rpm at 120° F. | 77 | 117 | 252 | 89 | 144 | 239 |
| 200 rpm at 120° F. | 64 | 87 | 198 | 74 | 112 | 192 |
| 100 rpm at 120° F. | 47 | 55 | 137 | 57 | 79 | 140 |
| 6 rpm at 120° F. | 30 | 20 | 64 | 36 | 38 | 76 |
| 3 rpm at 120° F. | 29 | 19 | 59 | 35 | 36 | 72 |
| Apparent Viscosity (cp) | 61 | 102 | 169 | 63 | 118 | 169 |
| Plastic Viscosity (cp) | 45 | 87 | 86 | 37 | 91 | 99 |
| Yield Point (lb/100 ft²) | 32 | 30 | 166 | 52 | 53 | 140 |
| Gel Strength, 0 min., 120° F. (lb/100 ft²) | 28 | 17 | 56 | 33 | 34 | 63 |
| Gel Strength, 10 min., 120° F. (lb/100 ft²) | 27 | 18 | 57 | 34 | 34 | 65 |
| HPHT Fluid Loss at 275° F. (ml) | <1 | 23.8^{a} | 42.2^{a} | <1 | 16.8^{a} | 29.8^{a} |
| Whole Mud Alkalinity (ml) | 0.79 | 0 | 0 | 0.12 | 0 | 0 |
| Excess Lime (lb/bbl) | 1.02 | 0 | 0 | 0.16 | 0 | 0 |
| Whole Mud Chlorides (mg/L) | 60,600 | 51,200 | 55,900 | 38,700 | 50,300 | 52,500 |
| Whole Mud Calcium (mg/L) | 35,000 | 34,600 | 37,400 | 34,920 | 35,000 | 39,400 |
| Oil Content (%) | 26.3 | 45.0 | 33.7 | 21.9 | 39.3 | 40.7 |
| Water Content (%) | 11.9 | 13.1 | 12.2 | 13.3 | 13.5 | 13.3 |
| Emulsion (%)^{b} | 13.9 | 9.8 | 24.0 | 18.6 | 16.1 | 8.2 |
| Solid Content (%) | 47.9 | 32.1 | 30.1 | 46.2 | 31.1 | 37.8 |

^{a}The HPHT filtrates of the hot rolled systems congealed and turned to fat.
^{b}A solid phase that passed through the condenser and into the tube was recorded as an emulsion.

### B. Performance of Cottonseed B100 Biodiesel and Its Mixtures with the Additive Packages Used in C-Mul® and CoastaLube®

### 1. Overview

The second stage of experimentation focused on evaluating Cottonseed B100 Biodiesel as a drilling fluid component, both by itself and in blends with the standard additive packages used in the polyalphaolefin-based commercial drilling fluid additives C-Mul® and CoastaLube®; in a simple, low-solids, nondispersed water-based 8 API drilling mud of 10.3 lb/gallon density and pH 10.3 (as measured by using a pH meter).

It is important to emphasize that these formulations did not contain polyalphaolefins. We were simply evaluating whether the standard additive packages (“add packs”) normally blended into a polyalphaolefin liquid in drilling fluid additives such as C-Mul® and CoastaLube® would perform similarly when they were instead blended into Cottonseed B100 Biodiesel.

The following ten specific samples were compared: (a) base mud; (b) base mud with 5%, 10% and 15% by volume of Cottonseed B100 Biodiesel only; (e) base mud with 5%, 10% and 15% by volume of Cottonseed B100 Biodiesel modified by blending with a standard C-Mul® additive package (available for purchase from the Sun Drilling Products Corporation), where the C-Mul® additive package comprises 7% by volume of the blend; and (d) base mud with 5%, 10% and 15% by volume of Cottonseed B100 Biodiesel modified by blending with with a standard CoastaLube® additive package (available for purchase from the Sun Drilling Products Corporation), where the CoastaLube® additive package comprises 5% by volume of the blend.

These measurements were performed at the laboratories of the Sun Drilling Products Corporation, in Belle Chasse, La. The results are summarized in TABLE 2.

TABLE 2
Properties of a simple, low-solids, nondispersed water-based 10.3 lb/gallon 8 API
drilling mud of pH 10.3; and of nine samples containing Cottonseed B100 (CS B100) Biodiesel.

| | | | | | Base + | Base + | Base + | Base + | Base + | Base + |
|---|---|---|---|---|---|---|---|---|---|---|
| | | | | | 5% By | 10% By | 15% By | 5% By | 10% By | 15% By |
| | | Base + | Base + | Base + | Volume | Volume | Volume | Volume | Volume | Volume |
| | | 5% By | 10% By | 15% By | CS B100 | CS B100 | CS B100 | CS B100 & | CS B100 & | CS B100 & |
| | | Volume | Volume | Volume | & C-Mul | & C-Mul | & C-Mul | CoastaLube | CoastaLube | CoastaLube |
| | Base | CS B100 | CS B100 | CS B100 | add pack | add pack | add pack | add pack | add pack | add pack |
| 600 rpm | 35 | 46 | 61 | 53 | 51 | 59 | 70 | 50 | 67 | 85 |
| 300 rpm | 20 | 26 | 36 | 31 | 30 | 36 | 43 | 30 | 41 | 54 |
| 200 rpm | 14 | 20 | 27 | 22 | 22 | 27 | 32 | 23 | 31 | 52 |
| 100 rpm | 9 | 13 | 17 | 13 | 14 | 17 | 20 | 15 | 20 | 28 |
| 6 rpm | 3 | 3 | 5 | 4 | 4 | 5 | 5 | 4 | 5 | 7 |
| 3 rpm | 3 | 3 | 4 | 3 | 3 | 3 | 4 | 3 | 4 | 6 |
| Apparent | 18 | 23 | 31 | 27 | 26 | 30 | 35 | 25 | 34 | 43 |
| Viscosity | | | | | | | | | | |
| (cp) | | | | | | | | | | |
| Plastic | 15 | 20 | 25 | 22 | 21 | 23 | 27 | 20 | 26 | 31 |
| Viscosity at | | | | | | | | | | |
| 120° F. (cp) | | | | | | | | | | |
| Yield Point | 5 | 6 | 11 | 9 | 9 | 13 | 16 | 10 | 15 | 23 |
| at 120° F. | | | | | | | | | | |
| (lb/100 ft²) | | | | | | | | | | |
| Gel Strength | 3/21/31 | 4/29/34 | 5/32/51 | 4/23/45 | 5/23/36 | 5/27/39 | 5/25/32 | 4/21/32 | 7/27/41 | 8/40/61 |
| at 120° F. | | | | | | | | | | |
| (lb/100 ft²), | | | | | | | | | | |
| 10/20/30 | | | | | | | | | | |
| minutes | | | | | | | | | | |
| API Fluid | 11 | 9 | 8.4 | 5.6 | 7.6 | 6.4 | 10.6 | 7.6 | 6 | 4.8 |
| Loss (ml) | | | | | | | | | | |
| API Filter | 3/32 | 3/32 | 4/32 | 2/32 | 3/32 | 2/32 | 2/32 | 2/32 | 2/32 | 2/32 |
| Cake | | | | | | | | | | |
| Thickness | | | | | | | | | | |
| (inch) | | | | | | | | | | |
| HPHT Fluid | 42 | 26 | 24.8 | 23.6 | 28 | 24 | 24 | 26.4 | 24.4 | 16.4 |
| Loss at | | | | | | | | | | |
| 250° F. (ml) | | | | | | | | | | |
| HTHP Filter | — | 10/32 | 10/32 | 10/32 | 9/32 | 9/32 | 8/32 | 11/32 | 9/32 | 8/32 |
| Cake | | | | | | | | | | |
| Thickness | | | | | | | | | | |
| at 250° F. | | | | | | | | | | |
| (inch) | | | | | | | | | | |

Metal-to-Metal Lubricity Test (at 60 rpm with a baseline frictional resistance of 150 inch · pounds)

| | | | | | | | | | | |
|---|---|---|---|---|---|---|---|---|---|---|
| Frictional | 24.3 | 23.5 | 22.6 | 13.5 | 18.2 | 10.5 | 10.3 | 12.7 | 8.7 | 6.1 |
| Resistance | | | | | | | | | | |
| (inch · | | | | | | | | | | |
| pounds) | | | | | | | | | | |
| % Reduction | — | −3.29 | −7.00 | −44.44 | −25.10 | −56.79 | −57.61 | −47.74 | −64.20 | −74.90 |

### 2. Discussion of Lubricity Behavior

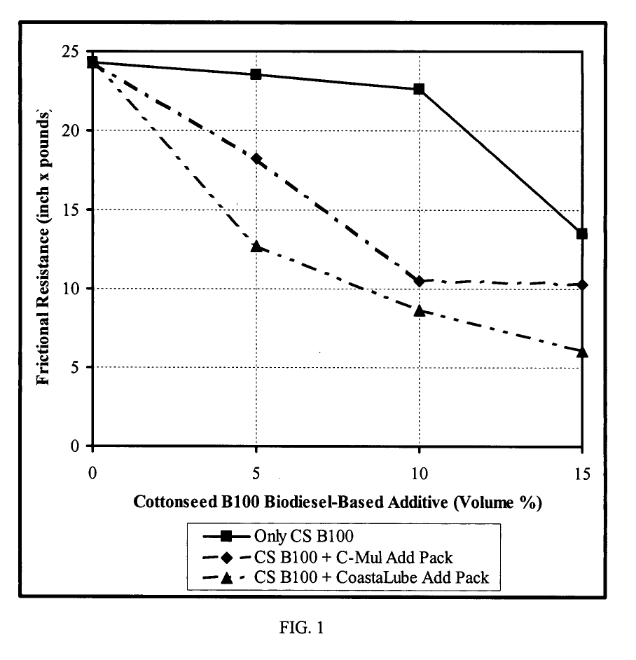

Most important since it evaluated the effectiveness of each formulation as a lubricant was the measurement of the frictional resistance of each formulation in a metal-to-metal lubricity test (where the metal was 4140 steel) performed by using a Baroid lubricity meter with a baseline frictional resistance of 150 inch·pounds. As a point of reference, frictional resistance levels ranging from 49.5 to 54.0 inch·pounds were observed when water was instead used as a lubricant. A lower measured frictional resistance level in this test indicates greater effectiveness as a lubricant. The results are illustrated in FIG. 1.

Even all by itself (without any additive package), Cottonseed B100 Biodiesel is seen to provide significant lubrication when incorporated into the drilling mud at 15% by volume. A drilling fluid compound where a standard C-Mul® and CoastaLube® additive package is blended into Cottonseed B100 Biodiesel is more effective, providing larger reductions in the coefficient of friction even when it is incorporated into the drilling mud at 5% by volume.

### 3. Discussion of Fluid Loss Behavior

a. Overview

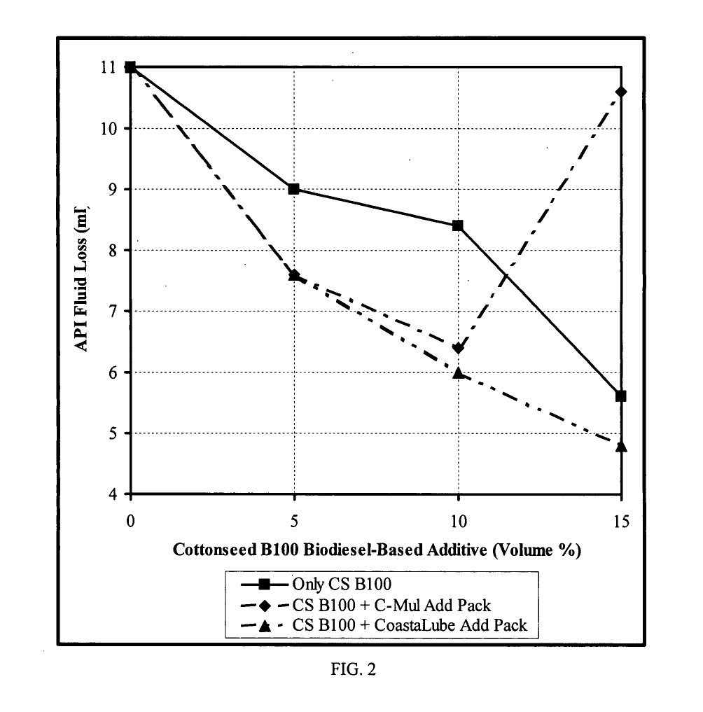

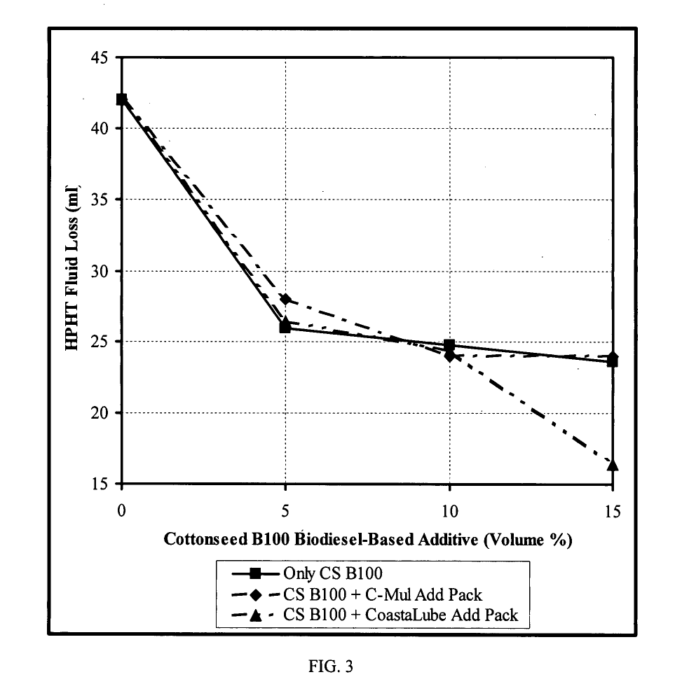

FIG. 2 shows the API fluid loss data and FIG. 3 shows the HPHT fluid loss data. Most importantly, it is seen that, for all nine samples containing a drilling fluid compound based on Cottonseed B100 Biodiesel, both the API fluid loss and the HPHT fluid loss is lower than the corresponding fluid loss for the base mud. This consistent trend demonstrates that drilling fluid compounds based on Cottonseed B100 Biodiesel perform as fluid loss control agents. In addition, more detailed insights can be obtained from a closer examination of the data, as will be summarized in the following paragraphs.

b. Additional Observations from API Fluid Loss Data

The following additional observations can be made for the API fluid loss from FIG. 2 and the numerical data listed in TABLE 2, with the sole exception of the data point for the sample that contains 15% of the drilling fluid compound with the C-Mul® additive package: (a) At any given volume percent incorporation into the base mud, samples containing a suitable additive package are more effective than Cottonseed B100 Biodiesel by itself in reducing fluid loss. (b) Fluid loss decreases with increasing volume fraction of a drilling fluid compound. (c) Fluid loss was lowered by 56% with the most effective system where 15% by volume of the Cottonseed B100 Biodiesel modified by the CoastaLube® additive package was incorporated into the base mud.

c. Additional Observations from HPHT Fluid Loss Data

The HPHT fluid loss experiment is likely to provide a more realistic estimate than the API fluid loss of the performance under real-life downhole conditions. The following additional observations can be made for the HPHT fluid loss at a temperature of 250° F. from FIG. 3 and the numerical data listed in TABLE 2: (a) There is a drastic reduction in fluid loss when 5% by volume of any of the three drilling fluid compounds is incorporated into the base mud. (b) There is a plateau-like region with little f uirther change in the amount of fluid loss as the concentration of drilling fluid compound is increased beyond 5% by volume, showing that the drilling mud has been “stabilized” so that it is less reactive and less subject to contamination once 5% by volume of any one of the three drilling fluid compounds has been incorporated in it. (c) Except for the most effective system, where 15% by volume of the Cottonseed B100 Biodiesel modified by the CoastaLube® additive package was incorporated into the base mud, the incorporation of an additive package into the Cottonseed B100 Biodiesel makes only a minor difference in fluid loss control effectiveness. (d) The most effective system, where 15% by volume of the Cottonseed B100 Biodiesel modified by the CoastaLube® additive package was incorporated into the base mud, results in the lowering of fluid loss by 61% relative to the base mud.

What is claimed:

1. A drilling fluid compound for use as an additive in a water-based drilling mud system, said compound comprising a B100 biodiesel-based formulation at a concentration of at least 5% by volume.

2. A base fluid for a synthetic-based drilling mud system, said base fluid comprising a B100 biodiesel-based formulation at a concentration of at least 5% by volume.

3. The drilling fluid compound of claim 1, comprising a polyalphaolefin, another isomerized olefin, or a combination thereof, as an optional additional component.

4. The base fluid of claim 2, comprising a polyalphaolefin, another isomerized olefin, or a combination thereof, as an optional additional component.

5. The drilling fluid compound of claim 1, where the B100 biodiesel used in said B100 biodiesel-based formulation is manufactured from oils, fats and greases obtained from plant sources, animal sources, or combinations thereof.

6. The base fluid of claim 2, where the B100 biodiesel used in said B100 biodiesel-based formulation is manufactured from oils, fats and greases obtained from plant sources, animal sources, or combinations thereof.

7. The drilling fluid compound of claim 1, where the B100 biodiesel used in said B100 biodiesel-based formulation is prepared by mixing B100 biodiesels that, prior to the mixing step, have been manufactured from oils, fats and greases obtained from plant sources, animal sources, or combinations thereof.

8. The base fluid of claim 2, where the B100 biodiesel used in said B100 biodiesel-based formulation is prepared by mixing B100 biodiesels that, prior to the mixing step, have been manufactured from oils, fats and greases obtained from plant sources, animal sources, or combinations thereof.

9. The drilling fluid compound of claim 5 or 7, where the oils, fats and greases are obtained from the group consisting of virgin vegetable and seed oils, such as soy, mustard, canola, rapeseed, mamouna, palm, babassu, pine, coffee, cottonseed, sunflower, jojoba, tung, castor, olive, peanut, cashew nut, pumpkin seed, corn, rice, perilla, sesame, coconut, safflower, linseed, hemp, Chinese tallow tree, tall oil, and similar types of oils; animal fats, such as poultry offal, tallow, lard, butter, neatsfoot and fish oils; and used cooking oils and trap grease from restaurants.

10. The base fluid of claim 6 or 8, where the oils, fats and greases are obtained from the group consisting of virgin vegetable and seed oils, such as soy, mustard, canola, rapeseed, mamouna, palm, babassu, pine, coffee, cottonseed, sunflower, jojoba, tung, castor, olive, peanut, cashew nut, pumpkin seed, corn, rice, perilla, sesame, coconut, safflower, linseed, hemp, Chinese tallow tree, tall oil, and similar types of oils; animal fats, such as poultry offal, tallow, lard, butter, neatsfoot and fish oils; and used cooking oils and trap grease from restaurants.

11. The drilling fluid compound of claim 1, where said drilling fluid compound satisfies the 275-day biodegradation test, 10-day Leptocheirus plumulosus toxicity test, and static sheen test.

12. The base fluid of claim 2, where said base fluid satisfies the 275-day biodegradation test, 10-day Leptocheirus plumulosus toxicity test, and static sheen test.

13. The drilling fluid compound of claim 11, where said B100 biodiesel-based formulation contains a petrodiesel, mineral oil, mineral oil derivative, or combination thereof, at a sufficiently small quantity that said drilling fluid compound satisfies said 275-day biodegradation test, 10-day Leptocheirus plumulosus toxicity test, and static sheen test.

14. The base fluid of claim 12, where said B100 biodiesel-based formulation contains a petrodiesel, mineral oil, mineral oil derivative, or combination thereof, at a sufficiently small quantity that said base fluid satisfies said 275-day biodegradation test, 10-day Leptocheirus plumulosus toxicity test, and static sheen test.

15. The drilling fluid compound of claim 1, where the concentration of B100 biodiesel-based formulation in said compound is in the range of 70% to 95% by volume.

16. A water-based drilling mud system, wherein the drilling fluid compound of claim 1 is present at a liquid volume concentration of 0.25% to 15.0%.
